(19) United States
(12) Patent Application Publication
(10) Pub. No.: US 2005/0086365 A1
(43) Pub. Date: Apr. 21, 2005

(54) System for adaptive bonding level for e-mail messages

(76) Inventor: Frank Urro, Billerica, MA (US)

Correspondence Address: Gregory P. Gadson, Esq., 19375 Amber Way, Noblesville, IN, 46060, US

(21) Appl. No.: 10/805,398

(22) Filed: Mar. 19, 2004

Related U.S. Application Data
(60) Provisional application No. 60/512,965, filed on Oct. 21, 2003.

(51) Int. Cl. G06F 15/16

(52) U.S. Cl. 709/237; 709/227

(57) ABSTRACT

A method of regulating electronic communications at least includes the following: indicating to a prospective communication sender that an intended communication recipient requires that the sender purchase a bond before a communication will be accepted by the recipient; accepting the communication if the sender has purchased the bond; rejecting the communication if the sender has not purchased the bond; establishing a feedback loop having as inputs, the amount of the bond and a desirable target communication rate, and having as an output, the actual rate at which bonded communications are received by a particular recipient; comparing the actual rate at which bonded communications are received by the particular recipient to the desirable target communication rate; and adjusting the amount of the bond when the actual rate differs from the target rate.

### CROSS-REFERENCE TO RELATED APPLICATIONS

This application is based on and claims the priority of U.S. Provisional Patent Application Ser. No. 60/512,965, filed Oct. 21, 2003 for “System for Adaptive Bonding Level for E-mail Messages.”

### BACKGROUND OF THE INVENTION

1. Field of the Invention

The present invention generally relates to methods for reducing unwanted electronic communications, with a non-limited emphasis upon “spam” and other forms of unwanted electronic mail. More particularly, the present invention relates to effectively being able to adjust mechanisms for deterring unwanted communications. Further, the present invention relates to regulating electronic communications targeted to highly sought individuals or entities.

2. Background

As is well known, electronic mail (“e-mail”) messages can be sent and received from almost any location using a computer or other device with a MODEM and an available telephone line. At the time of the initial filing of the application upon which this Letters Patent is based, well over 300 million hourly e-mail messages, and approximately 3 trillion yearly e-mail messages, were being sent to computer users.

To the chagrin of many e-mail users, much of the messages and attached files they receive can be classified as “spam.” In general, spam is unsolicited, mass-transmitted e-mail analogous to “junk” mail received by postal customers. Unlike postal junk mailers, “spammers” have very little increased cost associated with sending mass e-mailings, and are exponentially wreaking havoc.

Not only does spam overwhelm users' system resources and commandeer their time in order to delete unwanted messages, but it also transmits undesirable subject matter for many users. The undesirable subject matter for some, ranges from unwanted commercial solicitation, to chain mailings, to sexually explicit material.

One simplistic prior art approach to solving the problem of eliminating unwanted e-mail messages is for the user to compile a list of acceptable senders' e-mail addresses, or a list of banned senders' addresses, or both. Software on the user's computer system would then reject all incoming e-mail which is from a banned source, or which is from an unauthorized source. This approach has several problems; among them, rejecting perfectly legitimate e-mails the user would indeed have an interest in, simply because the sender's address does not appear on the list of authorized senders. This approach also places an untenable burden upon the user to constantly update the aforementioned list in order to avoid improper rejections. This approach also lacks the ability to recognize desirable senders whose e-mail addresses have changed unbeknownst to the recipient.

Another approach to eliminating unwanted e-mail messages is to install a filter on the user's system, or at the level of the Internet Service Provider (ISP) administering the user's e-mail account. Prior to presenting an e-mail message to the user, the filter peruses the e-mail for words or character strings that have been identified as tending to be associated with an undesirable communication. Regardless of how sophisticated these filters are, they often reject perfectly legitimate e-mail messages for failure to place the forbidden words in context. These filters also fail to reject undesirable messages that are cleverly worded to appear innocuous to filters, but yet contain subject matter the user would not otherwise like to receive.

In yet another approach, the user employs a third party to administer a filtering service for screening all e-mail messages. All e-mail sent to a service subscriber's address is routed to a server or other instrumentality under the control of the filter service operator.. The filtering service combines software and human screeners to review all messages, and pass to the subscriber, only those messages meeting the subscriber's positive and/or negative criteria. This approach adds extra cost to e-mail service, and while it may eliminate more of the cleverly worded but yet undesirable messages, nonetheless suffers from the same software limitations as previously mentioned approaches. It is also prone to human error. Compounding these problems is a loss of privacy on the part of the subscriber, as well as a requirement that the subscriber relinquish a degree of control to third parties who lack to personal experience and information to accept those messages which may appear to be forbidden on the surface, but might actually be desirable for receipt nonetheless.

A newer approach advocated, but yet to be successfully implemented commercially, is to charge an e-mail sender a fee for every message he or she sends. This is designed to make the price of spamming cost-prohibitive, while not leading to raised costs for typical e-mail users. While this can be controlled by ISPs who service the spammers, it will not discourage spammers whose ISPs do not charge for individual mail. Further, this moves away from the concept of e-mail for the masses which is not encumbered by a fee or taxing event for every message. It also requires those who send a large number of legitimate, desirable e-mails that are not seen as a nuisance, to pay unacceptably high up-front fees.

A further proposed refinement of the latter approach requires e-mail users to install special software that automatically assesses a fee (payable to the user) for each e-mail message from an unrecognized sender. The fee can be collected via the Internet Service Provider (ISP) where the sender and recipient have a common ISP. If not, the multiple ISPs involved can cooperate to charge the fee. If the user determines that the e-mail was desirable, he or she can cancel the charge. The fee is a matter of design choice, and can be, for example, in the $1 to $3 range.

While the latter approach may indeed serve as a deterrent to sending spam, it includes facets that make it impractical. Automatically and randomly charging senders having addresses unknown to the recipient, without their knowledge that they could be charged does not permit e-mail senders to adequately plan their costs associated with sending e-mails. Further, there is a financial incentive for some recipients to abuse the system by not canceling fees for legitimate e-mails, simply to collect the fee.

It should be noted that the problems associated with e-mail and unwanted messages are also present with other forms of electronic communication, such as, for example, telephone calls and facsimile transmissions. Solutions to reducing unwanted messages and contact for these other forms of communication are also inadequate.

U.S. Pat. No. 6,697,462, assigned to Vanquish, Inc., also the assignee of the present application, addressed the above-mentioned problems generally by allowing a recipient or prospective recipient of electronic communications to require that senders of these messages post a bond along with, or prior to sending the electronic communication. Further, (with knowledge to the sender) the bond is forfeited if the recipient rejects the communication upon receiving it or considering it. This is summarized in the aforementioned letters patent application in the following manner:
[T]he present invention provides a method of regulating electronic communications. The method at least includes the steps of receiving a communication from a sender for a designated recipient, comparing sender identity indicia attached to the communication with stored sender identity indicia in a data-base under the control of the recipient, and presenting the communication to the recipient for acceptance or rejection, when the sender identity indicia is determined to be acceptable. The method further at least includes the steps of sending a return message to the sender indicating that a bond must be posted when the sender identity indicia is not determined to be acceptable, and that money associated with the bond shall be forfeited if the communication is presented to the recipient and the recipient rejects the communication, dissolving the bond when the recipient accepts the communication, and causing the money associated with the bond to be forfeited when the recipient rejects the communication.
The present invention also provides a system for regulating electronic communications. The system includes, inter alia, at least a communication server adapted to receive a communication from a sender for a designated recipient, a sender identity indicia database adapted to store sender identity indicia under the direction of the recipient corresponding to acceptable or unacceptable sender identities, a comparator adapted to compare sender identity indicia attached to the communication with stored sender identity indicia database, and a bond establisher adapted to enable communication senders to establish bonds. The communication server is further adapted to present the communication to the recipient for acceptance or rejection, when the sender identity indicia is determined to be acceptable according to the output and interpretation of the comparator, and send a return message to the sender indicating that a bond must be posted when the sender identity indicia is not determined to be acceptable, and that money associated with the bond shall be forfeited if the communication is presented to the recipient and the recipient rejects the communication. The system is also adapted to dissolve the bond when the recipient accepts the communication, and cause the money associated with the bond to be forfeited when the recipient rejects the communication.
The present invention further provides a method of regulating electronic communications that at least includes the steps of receiving a communication from a sender for a designated recipient, and if the communication is accompanied by a posted bond, the amount of which is specified by the recipient, the recipient providing a guarantee that the communication will be accepted.

Along with the problems identified above, this application addresses the special problems associated with communications directed toward highly sought after or highly popular individuals or entities such as well-known business leaders, politicians, and the like. Even when a bonding approach is used such as one of the versions described above, the relative low cost to a typical sender (and not necessarily a “spammer”) still invites voluminous amounts of e-mail and other communications directed toward popular recipients. The prior art choices for a highly sought recipient seem to be: 1) continue to be overwhelmed by large amounts of communications, either ignoring messages en masse, or randomly reading some, or painstakingly reading all or most all messages; or 2) become unavailable to the mainstream public.

What is desirable is an approach that encourages motivated senders who believe they have meaningful communications to send them to highly sought recipients and have the communications read or heard by the recipients, while on the other hand limiting communications to a manageable level, and discouraging communications from senders who are not highly motivated or whose communications are mostly frivolous in nature.

It is also desirable to employ solutions that limit superfluous communications directed to highly sought after individuals and entities, to electronic communication recipients in general.

### SUMMARY OF THE INVENTION

In view of the aforementioned problems and deficiencies of the prior art, the present invention provides a method of regulating electronic communications at least including the following: indicating to a prospective communication sender that an intended communication recipient requires that the sender purchase a bond before a communication will be accepted by the recipient; accepting the communication if the sender has purchased the bond; rejecting the communication if the sender has not purchased the bond; establishing a feedback loop having as inputs, the amount of the bond and a desirable target communication rate, and having as an output, the actual rate at which bonded communications are received by a particular recipient; comparing the actual rate at which bonded communications are received by the particular recipient to the desirable target communication rate; and adjusting the amount of the bond when the actual rate differs from the target rate.

The present invention also provides a method of regulating electronic communications at least including: indicating to a prospective communication sender that an intended communication recipient requires that the sender purchase a bond before a communication will be accepted by the recipient; accepting the communication if the sender has purchased the bond; rejecting the communication if the sender has not purchased the bond; establishing a feedback loop having as inputs, the amount of the bond and target resources needed to reproduce received communications, and having as an output, the actual resources needed to reproduce bonded communications received by a particular recipient; comparing the actual resources needed to display or reproduce bonded communications received by the particular recipient to the target resources; and adjusting the amount of the bond when the actual resources differ from the target resources.

The present invention further provides a system for regulating electronic communications at least including: a plurality of prospective communication senders; at least one intended communication recipient; a bond indicator adapted to indicate to a prospective communication sender that an intended communication recipient requires that the sender purchase a bond before a communication will be accepted by the recipient; a bond purchase mechanism adapted to allow a communication sender to purchase a bond; a communication acceptor adapted to accept a communication if a sender has purchased a requisite bond; a communication rejecter adapted to reject a communication if a sender has not purchased a requisite bond; a feedback loop having as inputs, the amount of the bond and a desirable target communication rate, and having as an output, the actual rate at which bonded communications are received by a particular recipient; and a comparator operatively coupled to the feedback loop adapted to compare the actual rate at which bonded communications are received by the particular recipient to the desirable target communication rate; wherein the feedback loop is adapted to adjust the amount of the bond when the actual rate differs from the target rate.

### BRIEF DESCRIPTION OF THE DRAWING FIGURES

Features and advantages of the present invention will become apparent to those skilled in the art from the description below, with reference to the following drawing figures, in which:

FIG. 1 is a schematic block diagram of the present-inventive communication system for regulating communications between communication senders and communication recipients according to the present invention;

FIG. 2 is schematic block diagram illustrating the satisfaction bond level adjustment process according to the present invention;

FIG. 3 is a flow chart of the process of generating and sending electronic communications using an adjustable satisfaction bond level according to the present invention; and

FIG. 4 is a flow chart of an alternate embodiment of the present-inventive process of generating and sending electronic communications using a weighted value satisfaction bond approach.

### DESCRIPTION OF THE PREFERRED EMBODIMENTS

Although the description below is directed to a system for regulating e-mail messages in particular, the present invention is also applicable to other types of electronic communications, including but not limited to, telephone calls, facsimile transmissions, instant messages, and electronic text messages, forced browser popup messages.

Method Summary

the present invention attempts to regulate the rate and also the number of messages (if desired) received by highly sought after recipients by limiting the messages to a target rate/number. When a prospective sender attempts to send a message to an intended recipient, the sender is informed that he/she must post a bond in the amount requested by the intended recipient. The exact approaches used for establishment and payment of the bond are beyond the focus of the present invention, but can be handled in a number of ways, including sending the sender to a website, allowing billing through a secure online financial transaction using a credit card, charging the bond to the user's Internet Service Provider, and having the ISP later bill the sender, and others. The reader is referred to the aforementioned U.S. Pat. No. 6,697,462 for additional details concerning bonding in general. Messages accompanied by conforming bonds are presented to the recipient with a guarantee to the sender that the message will at least be read by the recipient, while messages unaccompanied by conforming bonds are automatically rejected by the system. In this manner, those senders who are highly motivated to communicate with the recipient can do so by taking a financial risk of sorts.

The recipient chooses a target (“desired”) rate of messages that he/she wishes to receive, or simple a number he/she wishes to receive over a defined time interval. Alternatively, the recipient can choose a default rate. The recipient also chooses an initial bond value (or directs the system to determine the initial bond value) that senders must use at the beginning of an e-mail cycle (e.g., at the beginning of a day, week, etc.). The rate of messages received is calculated and updated throughout the process by dividing the number of messages actually received by the time interval over which the messages have been received.

If the recipient is receiving more messages than desired (i.e., the received rate exceeds the target rate), the value of the bond that must be posted by a sender is automatically increased by a bond increment amount using a gain factor according to a Proportional Integral Derivative loop approach in the form of a feedback loop using the received rate, desired rate and bond value as inputs, and a new bond value as an output. The new bond amount adds the bond increment to the previous bond amount. In other words, the bond value is increased to discourage additional communications when too many messages are being received. The process is iterative.

In an alternate embodiment, the sender can post a bond exceeding a minimum value, which might encourage the recipient to read the message sooner, provide a personal response, or encourage other action on the part of the recipient that would be more favorable to the sender.

When the received rate is below the desired rate, the system can require that senders only post the initial bond value to have their message read by the intended recipient. Alternatively, the initial bond value can be lowered to encourage more messages until the desired and received rates match.

General System

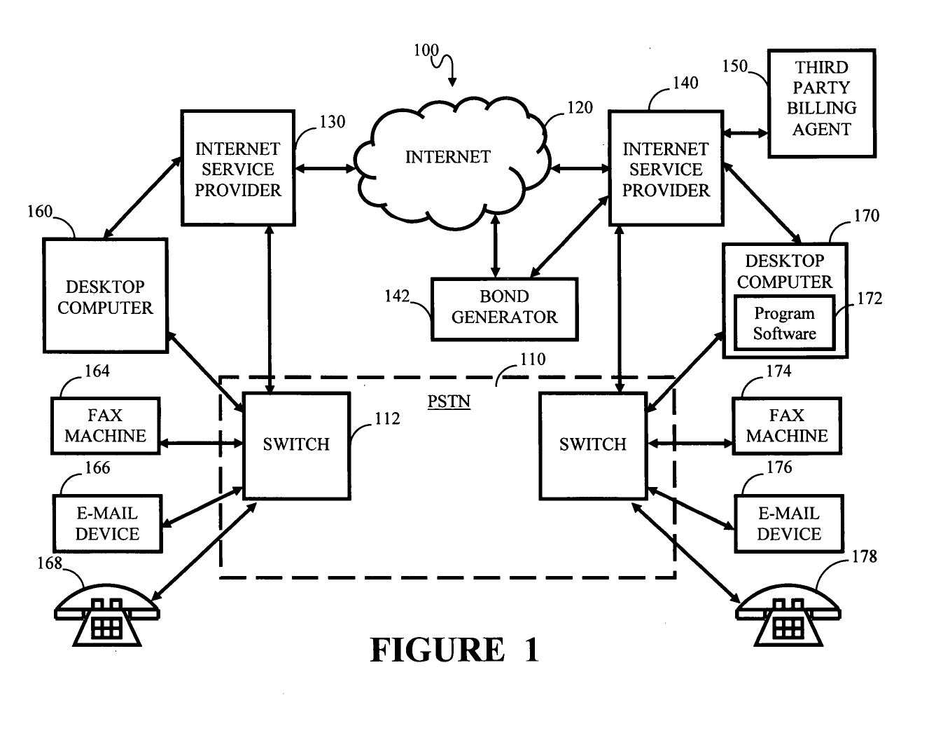

A general schematic block diagram of the present-inventive communication regulation system 100 is shown in FIG. 1. In the system 100, users can both send and receive a variety of electronic communications from a variety of sources, such as from computers (160, 170), facsimile machines (164, 174), special purpose hardware like electronic mail (e-mail) devices, or EMDs (166, 176), and conventional telephones (168, 178). Those skilled in the art to which the invention pertains will appreciate that other devices and other forms of communication can be regulated by the system without departing from the scope of the present invention. Further examples of these communications include “pop-up” menus and third party content messages received while a user is logged on to the Internet. Also, the devices can be connected to the system by both wired and wireless means.

In the preferred embodiment, the system 100 includes a Public Switched Telephone Network (PSTN) 110 for processing telephonic communications emanating from within and without the network. The details of a functioning PSTN are well known to those skilled in the art, and will thus not be repeated here, except to symbolically show telephonic switches 112 and 114. The present invention functions whether the communication is contained entirely within the PSTN, or whether there is extra-network handling. In an alternate embodiment, the connection to the PSTN may be bypassed entirely in favor of a cable modem connection, for communication between the ISP and the desktop computer.

Such extra-network handling includes communications which are transmitted and received through a wide area network (WAN) 120 such as the Internet. Connection to the Internet 120 is by way of one or more Internet Service Providers (ISPs) such as the ones 130 and 140.

A third party billing agent 150 handles financial transactions relating to credit cards and the like.

Users subscribing to the present inventive system and communication regulation service will have program software 172 installed in their computers for receipt of computer communications. Where the user receives a communication without a computer, the program software can be installed as part of the switches 112, 114, and/or as part of an Intelligent Network.

It is also the case that the present invention is applicable to message senders and recipients who are not subscribers to a particular system. A bond seller or bond generating entity 142 will either be contacted by a sender prior to attempting to send a message, or will be contacted after a recipient is informed that a bond is needed to send a particular message to an intended recipient.

The methods associated with the present invention, as described below, can be carried out by one or more communication servers under the control of the system ISPs, with each ISP having a separate server, or one or more centralized system servers.

Adaptive Bonding

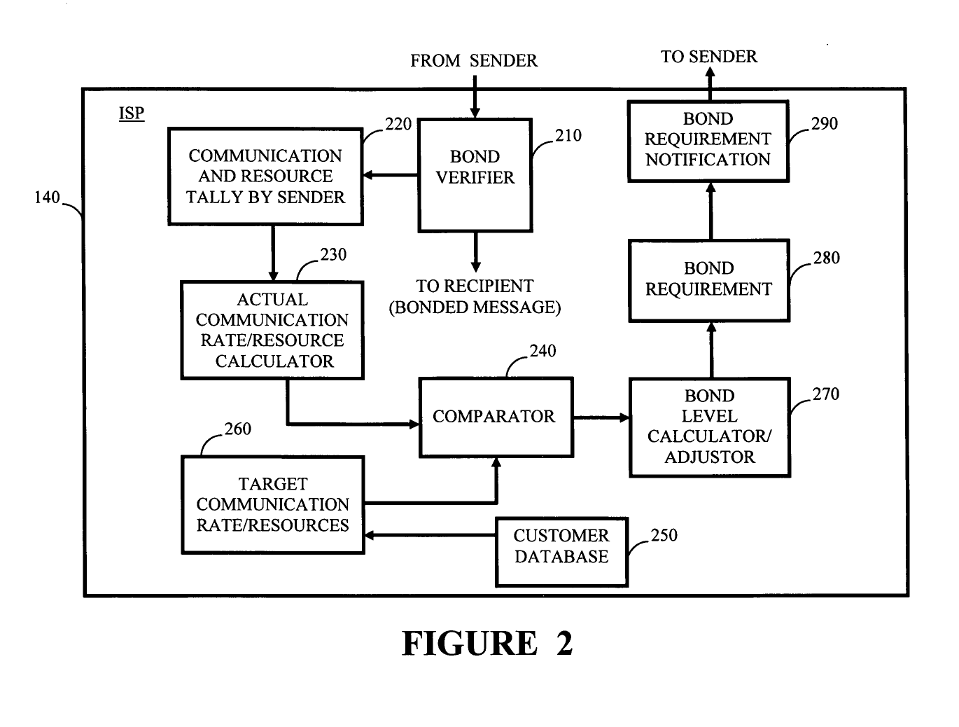

A functional block diagram of the components used to create adaptive bond levels is shown in FIG. 2. In the preferred embodiment, these components are under the control of the message recipient's ISP. Some of the functions of these components, however, can also be carried out partially by the message recipient's computer if appropriate software is installed thereon.

As is shown in FIG. 2, when a message is received from a message sender, a bond verifier 210 ascertains whether the message is accompanied by an appropriate satisfaction bond. If the message includes the requisite bond, it is passed to the intended message recipient. If not, the message is rejected and the bond requirement notification mechanism 290 informs the message sender of the appropriate bond needed to send a message to the particular targeted recipient.

For each recipient serviced, the ISP keeps a tally of the number of communications (element 220) for each identified sender. For each recipient, element 220 also keeps track of the resources used for each of the bonded messages from senders. For example, the “resources” can be in the form of the number of bytes of data that makes up the message, or the bandwidth needed to transmit or receive a message within a given amount of time. The resources are involved in reproducing the message. Here, “reproduce” means to display, or otherwise recreate the message in a user-perceivable form.

Processing by element 220 is followed by a calculation of the actual rate of messages received for the particular recipient (element 230). The rate of communications can be for example, the number of messages per hour, the number of messages per day, the number of messages per week, etc. Element 230 can also calculate the average resources needed for messages sent to a particular recipient over a given amount of time.

A customer database 250 supplies a target communication rate/resources element 260 with target rate or resource information, as required by the particular recipient. A comparator 240 compares the actual communication rate or resources to the target communication rate or resources, and outputs a difference signal. The difference signal is used to cause a bond level calculator/adjustor 270 to either increase, decrease, or maintain the bond amount required by the particular recipient. The aforementioned components function as a feedback loop to automatically adjust bond levels to stabilize the number of messages received by a recipient, or the resources used by messages received by a recipient to a desired level.

The bond level calculator/adjustor 270 stores the new bond level in a bond requirement element 280, whereupon the bond requirement notification element 290 can forward this information to prospective message senders. As was previously described, the bond level can be raised to discourage communication rates that are higher than desirable by the recipient, or to discourage communications that require more resources than are desired by the recipient. The bond level can also be lowered to encourage communication rates that are lower than desirable by the recipient, or to encourage communications that require fewer resources than can be comfortably accommodated by the recipient.

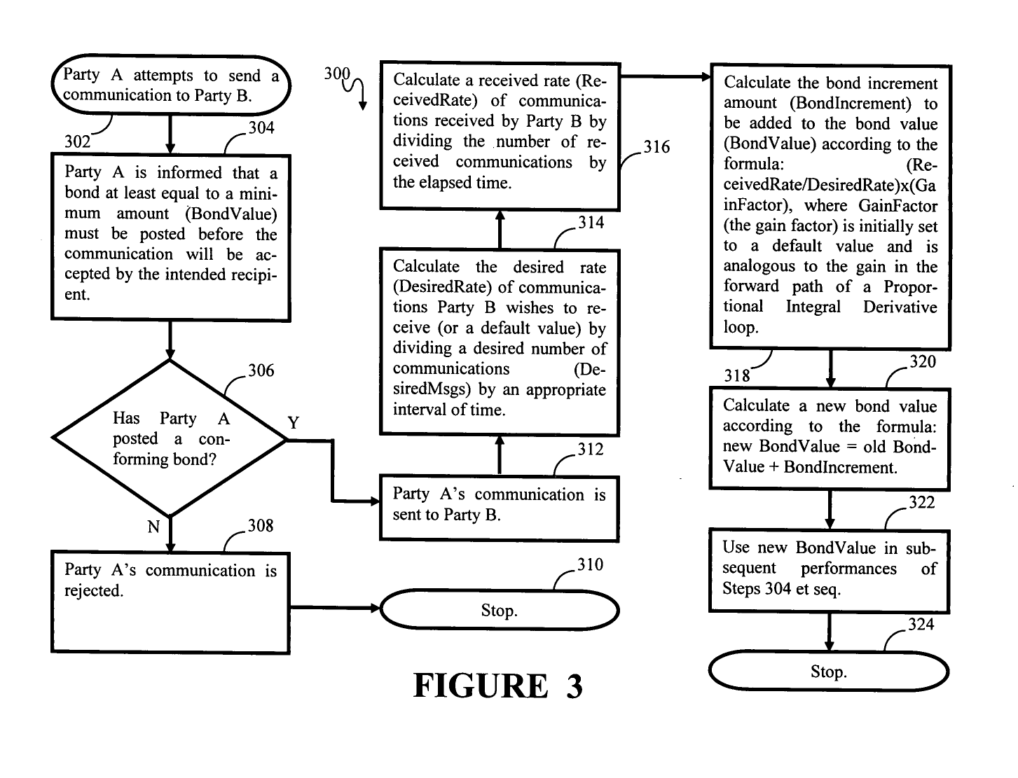

The algorithm 300 in FIG. 3 generally describes the basic steps employed by the present-inventive system for discouraging unwanted electronic communications. The algorithm begins in Step 302 when a message sender (Party A) attempts to send a message to a recipient (Party B).

In Step 304 Party A is informed that a bond at least equal to a minimum amount (BondValue) must accompany a message before that message will be accepted by Party B. If the message from Party A is not accompanied by the requisite bond amount the message is rejected and the algorithm stops (Steps 306, 308 and 310). If however, the message is accompanied by the requisite bond amount, the message is forwarded to the Party B (Steps 306 and 312).

Next, the algorithm calculates the desired rate of communications (DesiredRate) that Party B wishes to receive, or uses a default value. This can be calculated by dividing a desired number of communications (DesiredMsgs) by an appropriate interval of time (Step 314). In Step 316, the actual received rate (ReceivedRate) of communications received by Party B is calculated by dividing the number of received communications by the elapsed time equal in length to the interval used in Step 314.

Based upon a comparison of ReceivedRate and DesiredRate, a bond increment amount (BondIncrement) to be combined with the current bond amount is calculated in Step 318 by dividing the ReceivedRate by the DesiredRate, and multiplying the quotient by a gain factor (GainFactor). The gain factor is initially set to a default value (0.2 in the preferred embodiment) and is analogous to the gain in the forward path of a Proportional Integral Derivative loop. The gain factor along with other correction factors employed are self-tuning, with the amount of adjustment depending on the amount of previous error.

Step 320 calculates a new bond value according to Equation 1:
new BondValue=old BondValue+BondIncrement 1)

The new bond value is used in subsequent iterations of the process until the bond value is again updated (Step 322).

The process stops in Step 324.

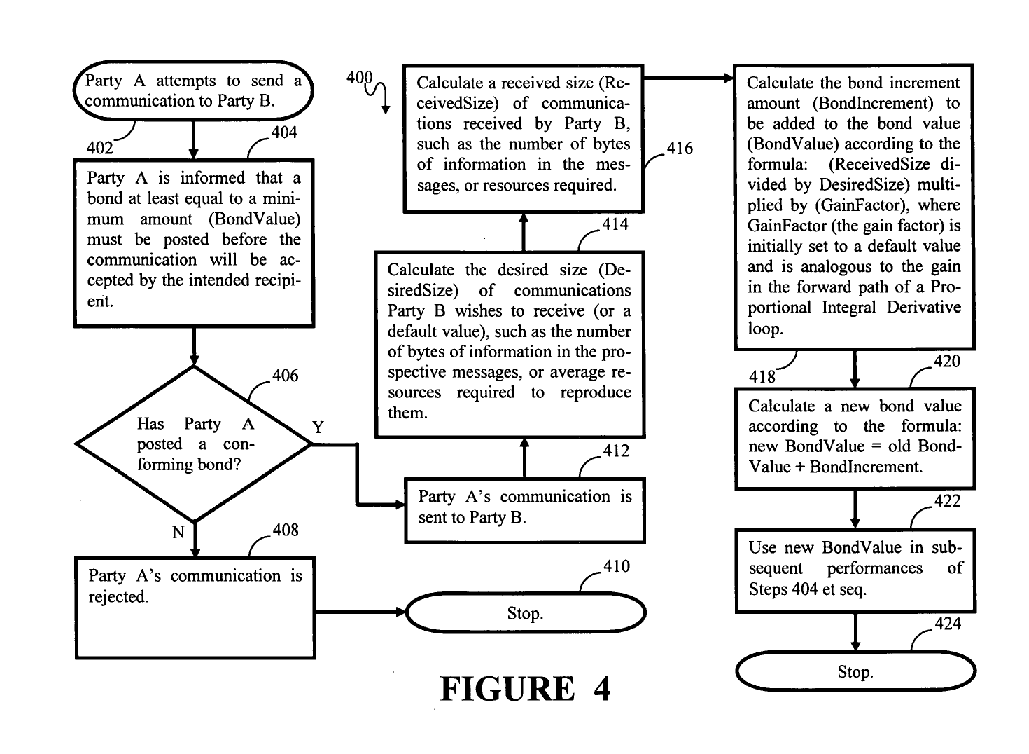

An alternative algorithm 400 in FIG. 4 can be used in place of the algorithm 300, when the recipient desires to base the bond value on the number of resources required by received messages (such as the number of bytes of information, or the bandwidth required to receive all of the information during a given interval). All of the steps of the algorithm 400 are identical to the steps of the algorithm 300, except for Steps 414-418.

In Step 414 the desired maximum size (DesiredSize) of the communications to be received by Party B are stored or calculated. In Step 416, the average received size (ReceivedSize) of bonded communications is calculated by averaging the amount of resources required of all of the accepted bonded communications. Additionally, the bond increment (BondIncrement) amount is calculated in Step 418 by dividing the ReceivedSize by the DesiredSize, and multiplying the quotient by a gain factor (GainFactor).

As yet another embodiment of the present invention, both algorithms 300 and 400 can be simultaneously employed.

Some Specific Variations

Variations and modifications of the present invention are possible, given the above description. However, all variations and modifications which are obvious to those skilled in the art to which the present invention pertains are considered to be within the scope of the protection granted by this Letters Patent.

One variation on the methods described above allows communication senders to purchase a guarantee that their communications will be reviewed and genuinely considered by highly sought after individuals and entities. For example, if an individual wishes to pitch a business proposition to a busy corporate chieftain, celebrity or governmental official, the individual can post a specified bond (e.g., fifty thousand dollars) for a specified amount of communication time (e.g., twenty minutes) with the targeted person. Using this approach, the busy, perpetually wooed individual can ensure that only the most serious-minded, determined individuals actually attempt to Is reach them. The money pledged under this approach is forfeited if the targeted individual or entity, upon actually reviewing and considering the communication, determines the communication to be unsatisfactory. In order to avoid the appearance that the highly sought after individual is merely trying to generate self-income, the money pledged can be paid to a charity or other third party independent of the individual. Pledges made to governmental officials must obviously meet ethical guidelines, and avoid the appearance of “influence peddling.”

Another variation of the present invention allows subscribers to indicate that they will receive all communications from specified commercial senders for a period of time, regardless of the nature of the communications. In exchange for the subscriber giving up his or her privilege to receive nuisance-free communications under the system, the subscriber might be paid a flat fee or periodic fees.

It is also possible to implement the present-inventive system using a clearinghouse-like entity/instrumentality, rather than placing all of the control under the ISPs. The clearinghouse can also serve as a dispute resolution entity, where subscribers can lodge complaints against other subscribers that may be abusing a “non-spam generator” presumption. It may also be used by subscribers to complain that other subscribers are simply rejecting legitimate communications to generate income, even though the income from the forfeited bonds may not go directly to the communication recipients.

1. A method of regulating electronic communications comprising:
a) indicating to a prospective communication sender that an intended communication recipient requires that said sender purchase a bond before a communication will be accepted by said recipient;
b) accepting said communication if said sender has purchased said bond;
c) rejecting said communication if said sender has not purchased said bond;
d) establishing a feedback loop having as inputs, the amount of said bond and a desirable target communication rate, and having as an output, the actual rate at which bonded communications are received by a particular recipient;
e) comparing the actual rate at which bonded communications are received by the particular recipient to the desirable target communication rate; and
f) adjusting the amount of said bond when the actual rate exceeds the target rate.

2. A method of regulating electronic communications comprising:
a) indicating to a prospective communication sender that an intended communication recipient requires that said sender purchase a bond before a communication will be accepted by said recipient;
b) accepting said communication if said sender has purchased said bond;
c) rejecting said communication if said sender has not purchased said bond;
d) establishing a feedback loop having as inputs, the amount of said bond and target resources needed to reproduce received communications, and having as an output, the actual resources needed to reproduce bonded communications received by a particular recipient;
e) comparing the actual resources needed to reproduce bonded communications received by the particular recipient to the target resources; and
f) adjusting the amount of said bond when the actual resources differ from the target resources.

3. A system for regulating electronic communications comprising:
a plurality of prospective communication senders;
at least one intended communication recipient;
a bond indicator adapted to indicate to a prospective communication sender that an intended communication recipient requires that said sender purchase a bond before a communication will be accepted by said recipient;
a bond purchase mechanism adapted to allow a communication sender to purchase a bond;
a communication acceptor adapted to accept a communication if a sender has purchased a requisite bond;
a communication rejecter adapted to reject a communication if a sender has not purchased a requisite bond;
a feedback loop having as inputs, the amount of said bond and a desirable target communication rate, and having as an output, the actual rate at which bonded communications are received by a particular recipient; and
a comparator operatively coupled to said feedback loop adapted to compare the actual rate at which bonded communications are received by the particular recipient to the desirable target communication rate;
wherein said feedback loop is adapted to adjust the amount of said bond when the actual rate differs from the target rate.

4. The method of claim 1, further comprising:
guaranteeing that a sender's communication accompanied by a requisite bond will be read or heard by the intended recipient.

5. The method of claim 1, wherein said bond amount is proportional to an established or perceived demand for a particular recipient's attention.

6. The method of claim 1, wherein said intended communication recipient is determined to be a popular recipient of communications.

7. The method of claim 1, further comprising establishing a maximum number of communications to be received by said intended recipient;
said target rate and said bond having values which encourage adherence to said maximum number.

8. The method of claim 1, further comprising:
allowing a prospective sender to establish a bond higher than the required bond amount, increasing the sender's odds that the intended recipient will read or hear a communication.

9. The method of claim 1, wherein electronic communications comprise electronic mail messages.

10. The method of claim 1, wherein electronic communications comprise telephone calls.

11. The method of claim 1, further comprising:
decreasing said bond amount when said actual rate is less than said target rate.

12. The method of claim 2, wherein said resources comprise the size of the information comprising the messages.

13. The method of claim 2, wherein said resources comprise the size of the information comprising the messages measured in bytes.

14. The method of claim 2, wherein said resources comprise the bandwidth needed to reproduce the information comprising the messages.

15. The system of claim 3, wherein said bond indicator is further adapted to guarantee that a sender's communication accompanied by a requisite bond will be read or heard by the intended recipient.

16. The system of claim 3, wherein said bond amount is proportional to an established or perceived demand for a particular recipient's attention.

17. The system of claim 3, wherein said intended communication recipient is determined to be a popular recipient of communications.

18. The system of claim 3, wherein said target rate comprises a maximum number of communications to be received by said intended recipient, and said target rate and said bond having values which encourage adherence to said maximum number.

19. The system of claim 3, wherein said feedback loop is further adapted to allow a prospective sender to establish a bond higher than the required bond amount, increasing the sender's odds that the intended recipient will read or hear a communication.

20. The system of claim 3, wherein electronic communications comprise electronic mail messages.
